(19) United States
(12) Patent Application Publication
(10) Pub. No.: US 2008/0186315 A1
(43) Pub. Date: Aug. 7, 2008

(54) Method and system for providing sound information to a user

(76) Inventor: Nicolas Bissantz, Nuremberg (DE)

Correspondence Address: DILWORTH & BARRESE, LLP, 333 EARLE OVINGTON BLVD., SUITE 702, UNIONDALE, NY, 11553, US

(21) Appl. No.: 11/703,874

(22) Filed: Feb. 7, 2007

(51) Int. Cl. G06T 11/20

(52) U.S. Cl. 345/440

(57) ABSTRACT

The present invention relates to a method for providing sound information to a user, the method comprising the steps of
displaying on a screen a sparkline which is composed of one or more than one graphical element, which graphical element(s) is/are based on one or more than one value and
providing a sound information to the user, wherein said sound information is related to the at least one graphical element which composes the sparkline or to the at least one value on which said at least one graphical element is based so that the tone characteristic, such as the tone pitch, tone colour, tone duration, tone kind or tone loudness of the sound information is in relation to the size or position of said at least one graphical element or to the magnitude of said at least one value.

The invention further relates to a system for providing information to a user.

### BACKGROUND OF THE INVENTION

The present invention relates to a method and to a system for providing sound information to a user.

In order to display a large amount of numerical information in a compact and intelligible form it is known from the prior art to use so called sparklines which are word-sized, miniaturized diagrams. Sparklines provide dense information in small spaces. For example, exchange rate movements, sports results, temperature variations etc. may easily be illustrated by use of such word-sized graphics. Sparklines for example consist of a column and/or bar diagram and/or line diagram in which the respective columns/bars/lines represent values, such as for example turnover values for different months.

### SUMMARY OF THE INVENTION

It is the object of the present invention to provide a method and a system for improving the users perception of the information related to a sparkline.

The inventive method comprises the steps of:
displaying on a screen a sparkline which is composed of one or more than one graphical element, which graphical element(s) is/are based on one or more than one value and
providing a sound information to the user, wherein said sound information is related to the at least one graphical element which composes the sparkline or to the at least one value on which said at least one graphical element is based so that the tone characteristic, such as the tone pitch, tone colour, tone duration, tone kind or tone loudness, of the sound information is in relation to the size or position of said at least one graphical element or to the magnitude of said at least one value.

The present invention is therefore based on the idea to provide a sound information to the user which sound information supports the optical information which is given on the screen. The information underlying a sparkline is mapped into a sound information. The sound information is in correspondence to the graphical element(s) of the sparkline or to the value(s) on the basis of which the sparkline is formed. For example, smaller values may be related to low-pitched sounds and higher values may be related to sounds which are in relation thereto high-pitched.

The present invention is not limited to the tone-pitch. Any conceivable property of a sound is covered by the present invention. Examples are the tone pitch, tone colour, tone duration, tone kind or tone loudness of the sound. The term “tone kind” for example covers the kind of the musical instrument, such as a drum etc., by means of which the respective tone is created.

The method and system according to the invention therefore remarkably increases the perception of the information content which is related to a sparkline and allows to easily acquiring the information content related to the sparkline by an acoustical support.

In accordance with a preferred embodiment of the present invention the sound information is consecutively provided for each or at least some of said graphical elements or portions of said graphical element or values on which the at least one graphical element is based.

In a preferred embodiment of the invention the method comprises the additional step of providing a triggering element and displaying said triggering element on the screen, wherein upon activation of said triggering element the sound information is provided to the user.

The triggering element for example may be the sparkline itself or an additional button displayed on the screen. If the user intends to be provided with the sound information the user for example performs a mouse click on the sparkline or on said button in order to be provided with the sound information related to the respective sparkline.

In order to further improve the inventive method the at least one graphical element (or a portion thereof) which composes the sparkline may be marked during the step of providing the sound information relating to this graphical element.

For example, said marking is performed by changing the colour or brightness or size or type of the graphical element. For example, if the sparkline is composed of columns it is conceivable to highlight the column which corresponding sound information is currently provided. Thus, the user is able to optically realize to which graphical element of the sparkline the currently provided sound information is related.

The type of the sparkline is also no limiting feature of the invention. The sparkline may for example be composed of columns or bars (i.e. horizontal elements) or of discrete data points or of one or more line elements. For example the sparkline may be composed of a number of columns or bars and the tone pitch of the sound information relates to the magnitude of the columns or bars. It is further conceivable that the sparkline is composed of data points and the sound information relates to the position of these data points for example in a Cartesian coordinate system.

The sparkline may for example also be a line element, for example a single line which displays values, for example turnover values vs. time. In this case the graphical element is composed of portions or single data points which—for example—correspond to a certain tone pitch or to any other feature of a tone which is noticeable by a user.

The present invention is further related to a system for providing information to a user, said system comprising displaying means for displaying on a screen a spark-line which is composed of one or more than one graphical element, which graphical element(s) is/are based on one or more than one value, said system further comprising sound creating means for providing a sound information to the user, wherein said sound information is related to the at least one graphical element which composes the sparkline or to the at least one value on which said at least one graphical element is based so that the tone characteristic, such as the tone pitch, tone colour, tone duration, tone kind or tone loudness, of the sound information is in relation to the size or position of said at least one graphical element or to the magnitude of said at least one value.

In accordance with a further embodiment of the present invention said sound creating means are adapted to consecutively provide sound information for each or at least some of the graphical elements or portions of said graphical element or values on which the at least one graphical element is based.

The system may further comprise means for displaying on the screen a triggering element which is adapted to initiate the provision of the sound information to the user upon activation of said triggering element.

The system may further comprise marking means for marking the at least one graphical element or portion thereof which composes the sparkline during the step of providing the sound information relating to this graphical element.

It is particularly preferred the system according to the invention comprises means to perform the method which is defined herein.

### DESCRIPTION OF THE PREFERRED EMBODIMENT

Further advantages of the present invention are explained on the basis of the following embodiment of the invention.

In a first embodiment on the display of a personal computer or a handheld device such as a mobile phone, etc. a sparkline is displayed to the user. The sparkline is composed of columns which are based on values, for example turnover values vs. time or time period. Of course, the present invention is not limited to this example and the sparkline may represent any other information which is conceivable for examples wins/losses, results of sporting events, etc.

If the user intends to be provided with a sound information the user activates a triggering element which may be the sparkline itself or a triggering button. As soon as the triggering element is activated the user is provided with a sound information which is composed of discrete sounds wherein the tone pitch of the sound corresponds to the size of the column or correspondingly to the value, i.e. the turnover value on which the respective column is based.

The means for providing the sound information are adapted so as to consecutively provide a sound for each of the graphical elements, i.e. the columns of the spark-line. Accordingly, the user is provided with a kind of melody and is able to easily comprehend the development of the values underlying the sparkline by listening to the sound information.

The present invention of course is not limited to sparklines which are composed of columns or bars. It is also conceivable for example that the sparkline is a line graph and that the sound information is related to the position of the data points or any other portions forming the line graph or to the values representing the line graph.

It is also conceivable not to provide discrete sounds but a continuous sound which changes the tone pitch or any other feature of the sound information according to the sparkline.

It is for example conceivable that discrete sounds are provided if discrete graphical elements are provided, such as bars or columns, and that a continuous sound is provided if a continuous graphical element (such as a line) is provided.

The present invention may be used for example on a personal computer, laptop, PDA or any other handheld device such as a mobile phone.

The method according to the present invention may be implemented in a computer program product.

1. Method for providing sound information to a user, comprising the steps of
displaying on a screen a sparkline which is composed of one or more than one graphical element, which graphical element(s) is/are based on one or more than one value, and
providing a sound information to the user, wherein said sound information is related to the at least one graphical element which composes the sparkline or to the at least one value on which said at least one graphical element is based so that the tone characteristic, such as the tone pitch, tone colour, tone duration, tone kind or tone loudness, of the sound information is in relation to the size or position of said at least one graphical element or to the magnitude of said at least one value.

2. Method for providing sound information to a user according to claim 1, wherein the sound information is consecutively provided for each or at least some of said graphical elements or portions of said graphical element or values on which the at least one graphical element is based.

3. Method for providing information to a user according to claim 1, wherein the method in addition comprises the step of providing a triggering element and displaying said triggering element on the screen, wherein upon activation of said triggering element the sound information is provided to the user.

4. Method for providing information to a user according to claim 3, wherein the triggering element is formed by the sparkline or by an additional button displayed on the screen.

5. Method for providing information to a user according to claim 1, wherein the at least one graphical element which composes the sparkline or a portion thereof is marked during the step of providing the sound information relating to this graphical element.

6. Method for providing information to a user according to claim 5, wherein said marking is performed by changing the colour, brightness, size or type of the graphical element.

7. Method for providing information to a user according to claim 1, wherein said sound information is composed of discrete sound or a continuous sound.

8. Method for providing information to a user according to claim 1, wherein the sparkline is composed of columns or bars or of data points or of one or more line elements.

9. System for providing information to a user, said system comprising displaying means for displaying on a screen a sparkline which is composed of one or more than one graphical element, which graphical element(s) is/are based on one or more than one value, said system further comprising sound creating means for providing a sound information to the user, wherein said sound information is related to the at least one graphical element which composes the sparkline or to the at least one value on which said at least one graphical element is based so that the tone characteristic, such as the tone pitch, tone colour, tone duration, tone kind or tone loudness, of the sound information is in relation to the size or position of said at least one graphical element or to the magnitude of said at least one value.

10. System for providing information to a user according to claim 9, wherein said sound creating means are adapted to consecutively provide sound information for each or at least some of the graphical elements or portions of said graphical element or values on which the at least one graphical element is based.

11. System for providing information to a user according to claim 9, wherein the system further comprises means for displaying on the screen a triggering element which is adapted to initiate the provision of the sound information to the user upon activation of said triggering element.

12. System for providing information to a user according to claim 9, wherein the system further comprises marking means for marking the at least one graphical element or a portion thereof which composes the sparkline during the step of providing the sound information relating to this graphical element or to the portion thereof.

13. System according to claim 9, wherein the system comprises means which are adapted to perform the method comprising the steps of
displaying on a screen a sparkline which is composed of one or more than one graphical element, which graphical element(s) is/are based on one or more than one value, and
providing a sound information to the user, wherein said sound information is related to the at least one graphical element which composes the sparkline or to the at least one value on which said at least one graphical element is based so that the tone characteristic, such as the tone pitch, tone colour, tone duration, tone kind or tone loudness, of the sound information is in relation to the size or position of said at least one graphical element or to the magnitude of said at least one value.

14. Method for providing information to a user according to claim 2, wherein the method in addition comprises the step of providing a triggering element and displaying said triggering element on the screen, wherein upon activation of said triggering element the sound information is provided to the user.

15. System for providing information to a user according to claim 10, wherein the system further comprises means for displaying on the screen a triggering element which is adapted to initiate the provision of the sound information to the user upon activation of said triggering element.

16. System for providing information to a user according to claim 15, wherein the system further comprises marking means for marking the at least one graphical element or a portion thereof which composes the sparkline during the step of providing the sound information relating to this graphical element or to the portion thereof.

17. System for providing information to a user according to claim 10, wherein the system further comprises marking means for marking the at least one graphical element or a portion thereof which composes the sparkline during the step of providing the sound information relating to this graphical element or to the portion thereof.

18. System for providing information to a user according to claim 11, wherein the system further comprises marking means for marking the at least one graphical element or a portion thereof which composes the sparkline during the step of providing the sound information relating to this graphical element or to the portion thereof.

19. Method for providing information to a user according to claim 14, wherein the triggering element is formed by the sparkline or by an additional button displayed on the screen.

20. Method for providing information to a user according to claim 19, wherein the at least one graphical element which composes the sparkline or a portion thereof is marked during the step of providing the sound information relating to this graphical element.
